(19) United States
(12) Patent Application Publication
(10) Pub. No.: US 2011/0113933 A1
(43) Pub. Date: May 19, 2011

(54) RATCHET WRENCH HAVING THE ADVANTAGES OF DURABILITY AND CONVENIENANCE OF USE

(76) Inventor: Hong-Jen Lee, Taichung (TW)

(21) Appl. No.: 12/618,764

(22) Filed: Nov. 15, 2009

(51) Int. Cl. B25B 13/46

(52) U.S. Cl. 81/63.1

(57) ABSTRACT

The present invention discloses a ratchet wrench with a head portion disposed at one end of a main body. A driving head is disposed in the head portion. A retaining portion is disposed on the driving head. The periphery of the retaining portion has three recess cuts each holding one pawl in a swing status. A circular chamber is disposed in the periphery of the retaining portion. Three pawls are pin-connected by three connecting pins so as to move together. The circular chamber is coupled with one triangular elastic piece. One rotatable disc and one cardioid spring are disposed on the head portion. When the rotatable disc is turned, the shift pin at the bottom of the rotatable disc drives the cardioid spring and one pawl, then the other two pawls move together so that the retaining teeth on one side of the pawl engage with the ratchet teeth, and further control the driving head on clockwise or counterclockwise driving.

### FIELD OF THE INVENTION

The present invention relates to a ratchet wrench, especially to a ratchet wrench has three pawls which can be moved together to control the ability of clockwise and counterclockwise driving, to disperse the reacted force and increase the stability when drive, and so as to achieve the purpose of increasing the durability and keeping the convenience of use.

### BACKGROUND OF THE INVENTION

For a conventional ratchet wrench structure, such as U.S. Pat. No. 4,497,227, the lateral side of the driving head holds one or two pawls. The retaining teeth of the pawl engage with the ratchet teeth on the inner wall of the head portion of the main body, and an upper lid is disposed on the head portion, and connected with a spring. One end of the spring connects the pawl. The rotation of the upper lid controls the spring to rotate. Then, the spring pushes the pawl to swing and engage with the ratchet teeth of the head portion by retaining teeth on left side or right side, and further control the driving head having the ability of clockwise or counterclockwise drive.

However, the disadvantages of the above-mentioned US Patent are as followings:

1. Controlling the ratchet wrench to make clockwise or counterclockwise turn relies on the upper lid to push the spring which makes the pawl to swing. During operation, the spring must bear a bigger reaction. It is easy to get elastic fatigue, and the retaining teeth of the pawl cannot properly engage with the ratchet teeth.

2. It is necessary to machine the upper lid to get a receiving chamber to hold the spring. However, the upper lid is not a circle. It requires milling. However, milling will increases the machining time and the cost of fabrication.

3. The actuation principle of the ratchet wrench requires a certain length of spring to fit an elastic action being produced when the retaining teeth of the pawl and the wretch gear are not relatively in mesh. The upper lid needs to receive a spring, and has a bigger diameter. Thus, the head portion of the wrench also needs a matching diameter. Therefore, one size of the upper lid and the pawl cannot fit different sizes of the wrench.

4. For assembling, if the two springs are firstly assembled with the pawl, and then the upper lid is assembled, it is not easy to align the two springs because the receiving chamber faces downward. It causes an assembling inconvenience.

There is another ratchet wrench disclosed in U.S. Pat. No. 6,769,330, whose operational end of the main body holds one driving head. The two lateral sides of the driving head hold two pawls. The retaining teeth of the pawl engage with the ratchet teeth on the inner wall of the main body. The two pawls are connected and positioned by two elastic elements. The advantage of the patent is that the elastic elements are wound around the periphery of the driving head. Thus, the elastic elements avoid the disadvantage that the spring mentioned in U.S. Pat. No. 4,497,227 occupies the space. However, the disadvantage of the aforementioned patent is: the elastic element is in form of wire, one end of the elastic element is disposed on the driving head and the other end is connected to the pawl, so that the ratchet wench is unable to make a clockwise or counterclockwise driving. In other words, the pawl cannot swing except one directional rotation. If the user wants to get another direction of rotation, he has to turn over the ratchet wrench to another side for use. Thus, the ratchet wrench of U.S. Pat. No. 6,769,330 is inconvenient in use.

### SUMMARY OF THE INVENTION

The primary object of the present invention is to provide a ratchet wrench with three pawls to move together in order to have a control on the ability of clockwise and counterclockwise driving, and to disperse the applied force for protecting the element of the ratchet wrench and increase the stability of the ratchet wrench when driving.

The technical measures: A retaining portion is disposed on the driving head of the head portion. There are three recess cuts in form of triangular column on the periphery of the retaining portion. A circular chamber is disposed on the periphery. Each recess cut receives one pawl in a swinging status. The top surface of the pawl is provided with one sunken hole and two connecting holes. The connecting holes of two adjacent pawls are insert-connected by the connecting pins at two ends of the connecting element. By means of three connecting elements, the three pawls can move together. The circular chamber is sleeved with one triangular elastic piece, and a rotatable disc and one cardioid spring are disposed on the head portion. When the rotatable disc is turned, the shift pin on the bottom of the rotatable disc can rotate the cardioid spring and one pawl. By means of the pawl and the three connecting elements, another two pawls move together so that the retaining teeth on one side of the pawl engage with the ratchet teeth. Thus, the driving head can be controlled on the clockwise and counterclockwise turns.

### BRIEF DESCRIPTION OF THE DRAWINGS

FIG. 1 is a three-dimensional exploded view in accordance with the present invention;

FIG. 2 is a perspective view with partial exploded section showing the inner assembly of partial structure in accordance with the present invention;

FIG. 3 is a perspective view of complete assembly in accordance with the present invention;

FIG. 4 is a top view in accordance with the present invention;

FIG. 5 is a cross-sectional view taken along line A-A of FIG. 4 in accordance with the present invention;

FIG. 6 is an inner action schematic view under clockwise rotation in accordance with the present invention; and

FIG. 7 is an inner action schematic view under counterclockwise rotation in accordance with the present invention.

### DETAILED DESCRIPTION OF PREFERRED EMBODIMENTS

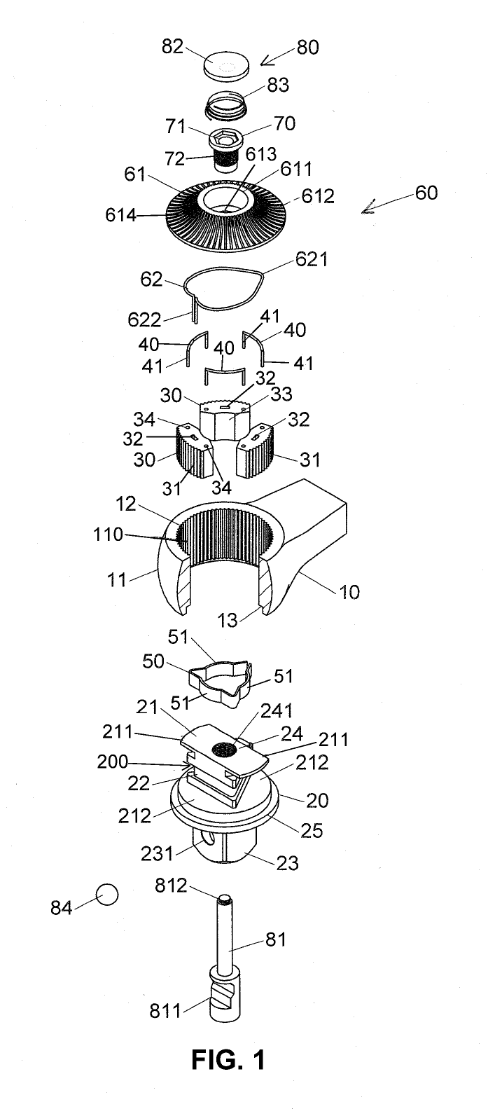

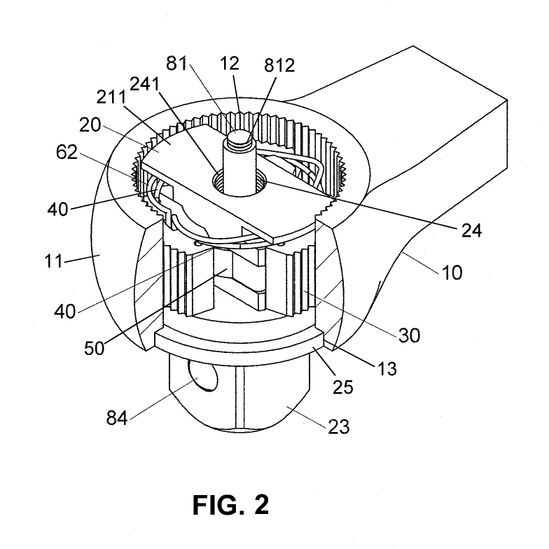

Referring to FIGS. 1 and 2, the ratchet wrench of the present invention comprising a main body 10, a driving head 20, pawls 30, connecting elements 40, an elastic piece 50, a control kit 60, a fixing element 70 and a quick-releasing kit 80, and the detail of afore-mentioned elements are described as followings:

one end of the main body 10 having one annular head portion 11, a plurality of ratchet teeth 12 annularly disposed on the inner wall 110 of the head portion 11, and an inner-diameter-enlarging circular chamber 13 disposed under the bottom end of the inner wall 110;

the driving head 20 rotatably disposed in the head portion 11, the lower section of the driving head 20 forming a quadrangle-column-shaped couple portion 23 which couples with a workpiece, a ball hole 231 disposed on one lateral side of the couple portion 23, a ball 84 being partially protruding outward and mounted in the ball hole 231, the periphery of the middle section of the driving head 20 being provided an outer-diameter-enlarging circular brim 25 thereon between the couple portion 23 and the upper section 200, the circular brim 25 being inserted in the circular chamber 13 of the main body 10, a first screw-thread section 241 and a longitudinal penetrating shoulder hole 24 disposed at the center of the driving head 20, the first screw-thread section 241 being provided at the upper section of the penetrating hole 24, the penetrating hole 24 going through the ball hole 231; wherein, three equal central-angle recess cuts 212 disposed on the periphery of the upper section 200 of the driving head 20 so that the upper section 200 forms one triangular-column retaining portion 21, the two sides of the top end of the retaining portion 21 protruding outward to form a fin piece 211 respectively, the overall length of the two fin pieces 211 being longer than the maximum width of the retaining portion 21, a circular chamber 22 disposed on periphery of the retaining portion 21;

one lateral side of the pawl 30 being provided with retaining teeth 31 which engage with the ratchet teeth 12 of the head portion 11, wherein the number of the pawls 30 being three, each pawl 30 being disposed in a recess cut 212 and having the capability of swing in the recess cut 212, a sunken cambered surface 33 being disposed on the center of the other lateral side opposite the lateral side having the retaining teeth 31, a sunken hole 32 being disposed on the top of the pawl 30, and two connecting holes 34 being disposed on the top of the pawl 30 and positioned at both sides of the sunken hole respectively;

by means of the connecting elements 40, the pawls 30 moving together, wherein the number of the connecting elements 40 is three, two ends of each connecting element 40 being bent and protruding outward to form a connecting pin respectively, the two connecting pins 41 of each connecting element 40 being inserted into the two connecting holes 34 of two adjacent pawls 30 respectively;

by means of the elastic piece 50, the pawls being pushed to mesh with the ratchet teeth 12 of the head portion 11, wherein, the elastic piece 50 being triangular and sleeved in the circular chamber 22, three raised cambered surfaces 51 being disposed at the centers of the three sides of the triangular elastic piece 50 respectively, the raised cambered surface 51 being inlaid in the sunken cambered surface 33 of the pawl 30, the raised cambered surface 51 being located at the center of the fin piece 211, the sunken cambered surface 33 being pushed by the elastic force of the raised cambered surface 51 when the pawl 30 and the ratchet teeth 12 being in mesh position, the sunken cambered surface of the pawl 30 being roundly supported by the elastic piece 50 when the pawl 30 being not in mesh and having a standby mesh function with the ratchet teeth 12, the elastic piece 50 being completely inlaid in and surround the circular chamber 22, and remaining the raised cambered surface 51 raised over the circular chamber 22; FIG. 1 illustrating the raised cambered surface 51 and the sunken cambered surface 33 are in circular arc shape;

the control kit 60 comprising a rotatable disc 61 and a cardioid spring 62, the rotatable disc 61 covering the top of the head portion 11 of the main body 10, knurled patterns 614 being disposed on top of the rotatable disc 61, a chamber hole 611 being disposed at the center of the top of the rotatable disc 61, a diameter-reducing penetrating hole 613 being disposed on the bottom of the chamber hole 611, and a shift pin 612 being disposed at an off-center position on the bottom of the rotatable disc 61; one end of the cardioid spring 62 being a tip 621, the shift pin 612 of the rotatable disc 61 being inlaid in the interior of the tip 621, another end of the cardioid spring 62 having an erect leg 622, the erect leg 622 being inserted in the sunken hole 32 of the pawl 30, as the principle of the conventional prior art, the shift pin 612 rotating the cardioid spring 62 when the rotatable disc 61 being turned, the erect leg 622 rotating one pawl 30 to swinging in one recess cut 212, and by means of the three connecting elements 40 of the present invention transmitting the force from the one pawl 30, the other two pawls 30 synchronically swinging in the other two recess cut 212;

the fixing element 70 having a second screw-thread section 72 and going through the chamber hole 611 of the rotatable disc 61, its second screw-thread section 72 being screw-coupled with the first screw-thread section 241 of the driving head 20 so that the rotatable disc 61 and the driving head 20 can be rotatably installed on the head portion 11 of the main body 10, and the fixing element 70 having a longitudinal penetrating hole 71;

the quick-releasing kit 80 comprising a control bar 81, a screw-couple element 82, a spring 83 and a ball 84, the control bar 81 going through the penetrating hole 24 of the driving head 20 from bottom to top, the periphery of the lower section of the control bar 81 having a sunken ball chamber 811, the ball chamber 811 being corresponding to the ball hole 231 of the couple portion 23, the wall surface of the ball chamber 811 being ladder-shaped, a third screw-thread section 812 being disposed on the top end of the control bar 81 and extending outward from the top opening of the penetrating hole 24, the thread-coupled element 82 being disposed in the chamber hole 611 of the rotatable disc 61 and being screw-coupled with the screw-thread section 812 of the control bar 81 by its screwed hole 820 (Referring to FIG. 5), the spring 83 being disposed in the chamber hole 611 of the rotatable disc 61, one end of the spring 83 pushing the bottom of the chamber hole 611, another end of the spring 83 pushing the thread-couple element 82, and the ball 84 being between the ball hole 231 and the ball chamber 811.

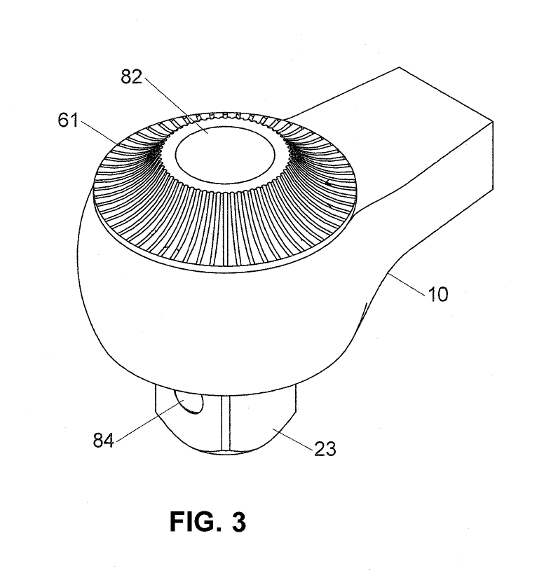

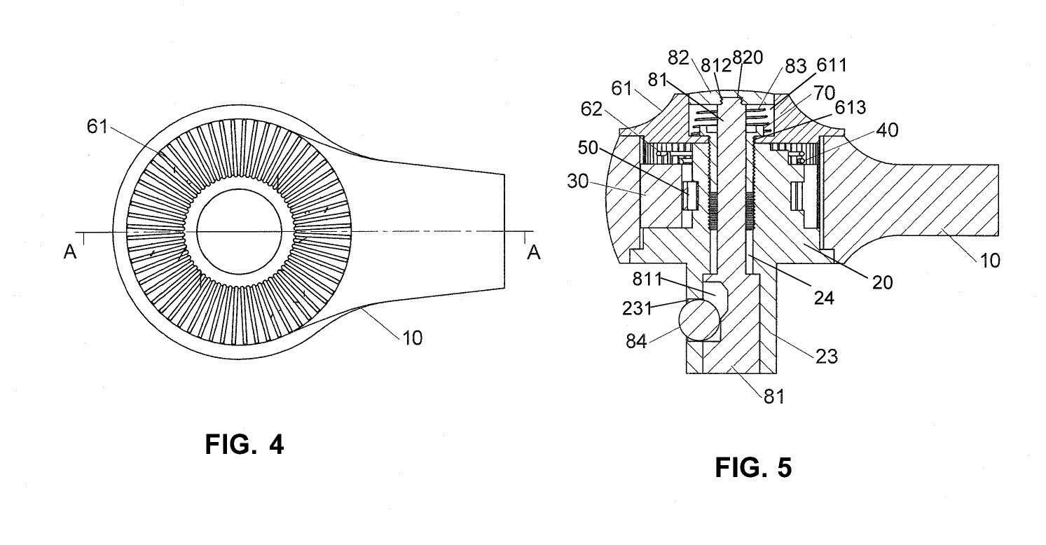

Referring to FIGS. 2-5, for assembly the elastic piece 50 is sleeved on the circular chamber 22, the driving head 20 is disposed in the head portion 11. The three pawls 30 are disposed in the three recess cuts 212 respectively. The three raised cambered surfaces 51 of the elastic piece 50 are inserted into the sunken cambered surface 33 of the three pawls 30 respectively. The two connecting pins 41 of each connecting element 40 are inserted to the connecting holes 34 of two adjacent pawls 30 respectively. The control bar 81 and the ball 84 are disposed in the penetrating hole 24 of the driving head 20. The rotatable disc 61 covers the top opening of the head portion 11. As the conventional prior art, the shift pin 612 is inserted in the interior of the tip 621 of the cardioid spring 62. The erect leg 622 of the cardioid spring 62 is inserted in the sunken hole 32 of the pawl 30. The fixing element 70 is disposed in the chamber hole 611 of the rotatable disc 61, and the second screw-thread section 72 is screw-coupled to the first screw-thread section 241 of the driving head 20. The spring 83 is disposed in the chamber hole 611 and at the position between the bottom of chamber hole 611 and the thread-couple element 82. The thread-couple element 82 is on top of the spring 83, and screw-coupled to the third screw-thread section 812 of the control bar 81.

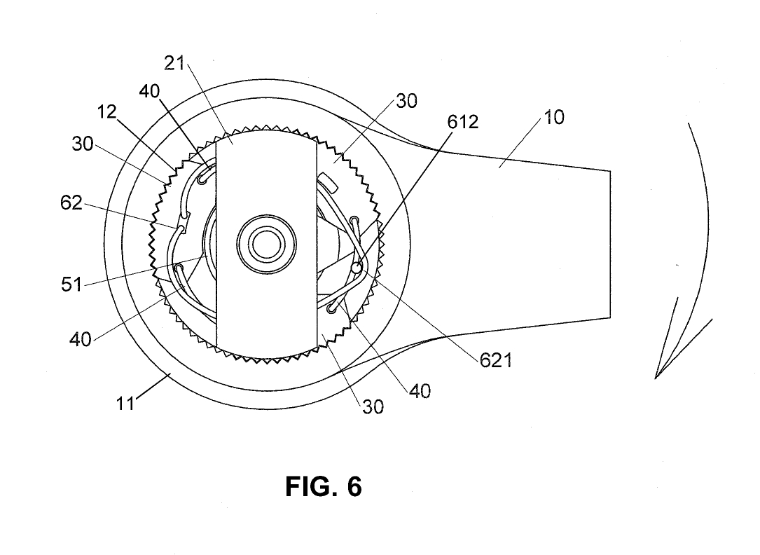

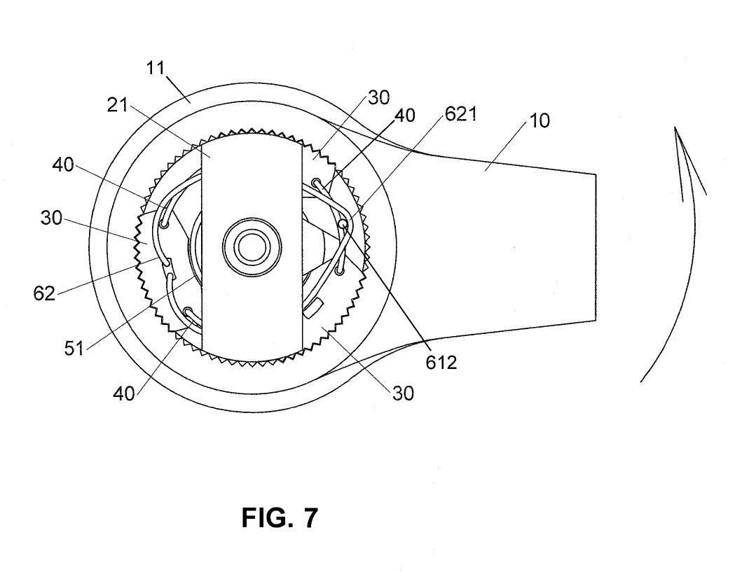

Referring to FIGS. 1, 6 and 7, for operating the ratchet wrench, the user turns the rotatable disc 61. Through the actions of shift pin 612, cardioid spring 62 and the connecting elements 40, the three pawls 30 swing in the recess cut 212 to make a selection whether the retaining teeth 31 on left side or right side of the pawl 30 should engage with the ratchet teeth 12 of the head portion 11 of the main body 10, and further control the driving head 20 to switch between clockwise and counterclockwise driving (the principle of this manner is the same with conventional prior art). According to the present invention, because the sunken cambered surface 33 of the pawl 30 is pushed by the raised cambered surface 51 of the elastic piece 50, the retaining teeth 31 of the pawl 30 and the ratchet teeth 12 of the main body 10 are kept in mesh status. FIG. 6 is a schematic drawing showing a clockwise driving. FIG. 7 is a schematic drawing showing a counterclockwise driving.

Therefore, according to the above-mentioned embodiment, we can conclude the structure of the ratchet wrench of the present invention has the advantages as followings:

1. Three synchronic moving pawls 30 are employed to control the driving head on clockwise and counterclockwise turns, and to reduce the applied force to the pawls. Besides, the elastic piece 50 has three sides to share the applied force to the three pawls 30 so that the elastic piece 50 can avoid fatigue.

2. The elastic piece 50 is in the circular chamber 22, and does not occupy a large space. It fits different sizes of the ratchet wrench.

3. The raised cambered surface 51 with elasticity is located at the center of one lateral side of the elastic piece 50, and inlaid in the sunken cambered surface 33 of the pawl 30 so that the pawl can move freely, and has an effective push force.

4. The elastic piece 50 in form of thin triangle is sleeved in the circular chamber 22, and does not occupy space. The penetrating hole 24 can be designed according to the standard diameter size so as to install a quick-releasing kit 80.

While we have shown and described the embodiment in accordance with the present invention, it should be clear to those skilled in the art that further embodiments may be made without departing from the scope of the present invention.

What is claimed is:

1. A ratchet wrench comprising a main body, a driving head, pawls, connecting elements, an elastic piece, a control kit and a fixing element; one end of the main body having an annular head portion, a plurality of ratchet teeth being annularly disposed on the inner wall of the head portion; the driving head being rotatably disposed in the head portion, the lower section of the driving head forming a column-shaped couple portion which is provided for coupling with a workpiece, a ball being partially protruding outward and disposed on one lateral side of the column-shaped couple portion, a first screw-thread section being disposed at the center of the driving head; one lateral side of the pawl being provided with retaining teeth, by means of the elastic piece and the connecting elements, the pawls moving together and mesh with the ratchet teeth of the head portion by the retaining teeth; the control kit comprising a rotatable disc and a cardioid spring, the rotatable disc covering the top of the head portion of the main body, a chamber hole being disposed at the center of the top of the rotatable disc, a diameter-reducing penetrating hole being disposed on the bottom of the chamber hole, and a shift pin being disposed at an off-center position on the bottom of the rotatable disc; one end of the cardioid spring being a tip, the shift pin of the rotatable disc being inlaid in the interior of the tip, another end of the cardioid spring having an erect leg, the erect leg being inserted in a sunken hole of the pawl, the shift pin rotating the cardioid spring when the rotatable disc being turned, the erect leg rotating one pawl to swinging in the recess cut; the fixing element having a second screw-thread section and going through the chamber hole of the rotatable disc, the second screw-thread section being screw-coupled with the first screw-thread section of the driving head;
wherein:
three equal central-angle recess cuts being disposed on the periphery of the upper section of the driving head so that the upper section forming a triangular-column retaining portion, the two sides of the top end of the retaining portion protruding outward to form a fin piece respectively, the overall length of the two fin pieces being longer than the maximum width of the retaining portion, a circular chamber being disposed on periphery of the retaining portion;
the number of the pawls being three, each pawl being disposed in a recess cut and having the capability of swing in the recess cut, a sunken cambered surface being disposed on the center of the other lateral side opposite the lateral side having the retaining teeth, a sunken hole being disposed on the top of the pawl, and two connecting holes being disposed on the top of the pawl and positioned at both sides of the sunken hole respectively;
the number of the connecting elements being three, two ends of each connecting element being bent and protruding outward to form a connecting pin respectively, the two connecting pins of each connecting element being inserted into the two connecting holes of two adjacent pawls respectively; and
the elastic piece being triangular and sleeved in the circular chamber of the retaining portion, three raised cambered surfaces being disposed at the centers of the three sides of the triangular elastic piece respectively, the raised cambered surface being inlaid in the sunken cambered surface of the pawl.

2. The ratchet wrench as claimed in claim 1, wherein an inner-diameter-enlarging circular chamber is disposed under the bottom end of the inner wall of the head portion, the periphery of the middle section of the driving head is provided an outer-diameter-enlarging circular brim thereon, the circular brim is inserted in the circular chamber of the main body.

3. The ratchet wrench as claimed in claim 1, wherein a longitudinal penetrating shoulder hole is disposed at the center of the driving head, the first screw-thread section is provided at the upper section of the penetrating shoulder hole, the second screw-thread section of the fixing element is going through the chamber hole of the rotatable disc and is screw-coupled with the first screw-thread section in the penetrating shoulder hole of the driving head.

4. The ratchet wrench as claimed in claim 3, wherein a control bar goes through the penetrating shoulder hole of the driving head, the periphery of the lower section of the control bar has a sunken ball chamber corresponding to a ball hole of the couple portion of the driving head which is provided for receiving the ball, the wall surface of the ball chamber is ladder-shaped, a third screw-thread section is disposed on the top end of the control bar and extends outward from the top opening of the penetrating shoulder hole, a thread-coupled element is disposed in the chamber hole of the rotatable disc and is screw-coupled with the third screw-thread section of the control bar, a spring is disposed in the chamber hole of the rotatable disc, one end of the spring pushing the bottom of the chamber hole, another end of the spring pushing the thread-couple element, and the ball is positioned between the ball hole and the ball chamber.

5. The ratchet wrench as claimed in claim 1, wherein knurled patterns disposed on the top of the rotatable disc.

6. The ratchet wrench as claimed in claim 1, wherein the elastic piece is completely inlaid in and surround the circular chamber, and remains the raised cambered surface raised over the circular chamber.

7. The ratchet wrench as claimed in claim 1, wherein the column-shaped couple portion is quadrangular.

8. The ratchet wrench as claimed in claim 1, wherein the raised cambered surface and the sunken cambered surface are in circular arc shape, the sunken cambered surface is pushed by the elastic force of the raised cambered surface when the pawl and the ratchet teeth being in mesh position, the sunken cambered surface of the pawl being roundly supported by the elastic piece when the pawl being not in mesh and having a standby mesh function with the ratchet teeth.
